(19) United States
(12) Patent Application Publication
(10) Pub. No.: US 2002/0156930 A1
(43) Pub. Date: Oct. 24, 2002

(54) System, method, and article of manufacture for facilitating communication between an IMS process and CORBA process

(76) Inventor: Alan S. Velasquez, Piscataway, NJ (US)

Correspondence Address: Orville R. Cockings, Esq., Telcordia Technologies, Inc., 445 South Street, Morristown, NJ, 07960, US

(21) Appl. No.: 09/841,590

(22) Filed: Apr. 24, 2001

(51) Int. Cl. G06F 9/54

(52) U.S. Cl. 709/310

(57) ABSTRACT

Methods and systems consistent with the present invention facilitate communication between an IMS process running in an IMS environment of a first computer and a CORBA process running on a second computer. In accordance with an embodiment, a message destined to the CORBA process may be received from the IMS process. The message may be converted, outside of the IMS environment but within the first computer, to a format recognizable by the CORBA process. The converted message may then be sent to the CORBA process. Accordingly, in this embodiment, the interface may facilitate communication between the IMS process and the CORBA process without impacting the performance of the IMS environment.

### BACKGROUND OF THE INVENTION

1. Field of the Invention

The present invention relates generally to the Information Management System (IMS) operating environment and, more particularly, to a system, method, and article of manufacture for facilitating communication between an IMS process and a Common Object Request Broker Architure (CORBA) process.

2. Background Information

Information Management System (IMS) or Information Management System/Enterprise Systems Architecture (IMS/ESA) refers to an operating environment for running processes that may perform various tasks, such as database management and transaction processing. These processes (herein referred to as “IMS processes”) may be written in many different programming languages, such as COBOL, PL/I, C, VS Pascal, Ada, REXX, and Assembler.

IMS processes use the resources of the IMS environment to perform tasks, such as processing messages (e.g., deposits and withdrawals to and from customer accounts for a bank).

For example, a control region of an IMS environment may receive a message from a client 20 terminal (e.g., computer) and send the message to a message queue. Then, an IMS scheduler may notify an available message region of a pending message in the message queue and start an IMS process in this message region. The IMS process may in turn get the message from the message queue and process the message.

Many industries, such as telecommunications and banking rely heavily on IMS processes and the IMS environment. One drawback to using the IMS environment, however, is that IMS processes generally cannot communicate with newer technologies or standards without considerable expense and performance trade offs. One such contemporary standard is Common Object Request Broker Architecture (CORBA). Many organizations use CORBA compliant processes because of their interoperability with each other. For example, two CORBA processes may communicate with one another regardless of whether or not the two processes are written in the same programming language, are sold by the same vendor, are running on the same operating system, or are running on the same network. A CORBA process may communicate with another CORBA process, for example, using GIOP (General Inter-Orb Protocol) or IIOP (Internet InterOrb Protocol).

A CORBA process may include objects, such as individual software units that combine functionality and data. Furthermore, for a CORBA process, an interface defines the characteristics and behavior of an object, including the operations that can be performed on the object. An operation may include an action that can be performed on an object given a specified set of arguments. The interface may include a method, such as a program code corresponding to each operation that can be performed on an object. The interface may be defined using the Object Management Group (OMG) interface definition language (IDL). For example, a CORBA process may send a message to another CORBA process to perform a certain operation on an object. Before sending the message, however, the first process may format the message based on the interface definition language of the second process. The second process may receive the message and invoke the method corresponding to the desired operation on the object.

One solution for facilitating communication between an IMS process and a CORBA process running on separate computers may be to use an external process that uses screen scraping and runs on an intermediary computer. Specifically, the external process may request a message from the IMS process using screen scraping, filter the received message, format a message for the CORBA process, and send the message to the CORBA process.

Implementing and maintaining this external process and intermediary computer, however, may be costly and difficult to integrate with existing processes. Moreover, the performance of the IMS environment (e.g., region occupancy and throughput rates) may be affected because the message region may have to wait for the external process to process a message before the message region can process another message. Furthermore, the external process may not be able to handle unsolicited or asynchronous messages from the IMS processes. Another problem with this solution is that the CORBA process may not be able to send messages to the IMS processes running in the IMS environment.

### SUMMARY OF THE INVENTION

Methods and systems consistent with the present invention facilitate communication between an IMS process running in an IMS environment of a first computer and a CORBA process running on a second computer. A message destined to the CORBA process may be received from the IMS process. The message may be converted, outside of the IMS environment but within the first computer, to a format recognizable by the CORBA process. The converted message may then be sent to the CORBA process.

To convert the message, the message may be parsed and the data from the parsed message may be inserted into one or more interface definition language structures recognizable by the CORBA process.

Methods and systems consistent with the present invention may also receive a message destined to the IMS process from the CORBA process. The message may be converted, outside of the IMS environment but within the first computer, to a format recognizable by the IMS environment. The converted message may then be sent to the IMS environment. In addition, a response may be received outside of the IMS environment but within the first computer. The response may then be sent to the CORBA process.

To convert the message, the message may be parsed and the data from the parsed message may be inserted into a structure recognizable by the IMS process.

Both the foregoing and the following description are exemplary and explanatory and are intended to provide further explanation of the claimed invention as opposed to limiting it in any manner.

### BRIEF DESCRIPTION OF THE DRAWINGS

The accompanying drawings are incorporated in and constitute a part of this specification, and together with the description, explain the principles of the invention. In the drawings:

FIG. 1 is an exemplary block diagram of a system, in accordance with methods and systems consistent with the present invention;

FIG. 2 is an exemplary block diagram of the several processes in an interface, in accordance with methods and systems consistent with the present invention;

FIG. 3 is an exemplary block diagram of the sub-processes in a listen process, in accordance with methods and systems consistent with the present invention;

FIGS. 4 and 5 are exemplary flowcharts illustrating the steps performed in an IMS environment to process a message, in accordance with methods and systems consistent with the present invention;

FIG. 6 is an exemplary flowchart illustrating the steps performed by a listen process, in accordance with methods and systems consistent with the present invention;

FIG. 7 is an exemplary flowchart illustrating the steps performed by a talk process, in accordance with methods and systems consistent with the present invention; and

FIG. 8 is an exemplary flowchart illustrating the steps performed by a send process, in accordance with methods and systems consistent with the present invention.

### DETAILED DESCRIPTION

The following detailed description of the invention refers to the accompanying drawings. While the description includes exemplary embodiments, other embodiments are possible and changes may be made to the embodiments described without departing from the spirit and scope of the invention. The following detailed description does not limit the invention. Instead, the appended claims and their equivalents define the scope of the invention.

Methods and systems consistent with the present invention provide an interface to facilitate communications between an IMS process running in an IMS environment and a CORBA process. In accordance with an embodiment of the invention, the interface may include a listen process, a talk process, and a send process, all of which may run on the same computer as the IMS process, but outside of the IMS environment. Accordingly, in this embodiment, the interface may facilitate communication between the IMS process and the CORBA process without impacting the performance of the IMS environment. In addition, the interface may include several methods that the CORBA process may invoke to communicate with the IMS process.

For example, when the IMS process needs to communicate with the CORBA process, the IMS process may send a message to the listen process that may be waiting for a message. The listen process may parse the message and format the message for the appropriate method call based on the interface definition language of the CORBA process. After formatting, the listen process may send the message to the CORBA process.

On the other hand, when the CORBA process wishes to communicate with the IMS process, the CORBA process may send a message to the interface. The message may include reference to the method that needs to be invoked and any inputs needed to invoke that method. Depending on the method invoked by the CORBA process, the talk process or the send process may process the message. If the method requires a response from the IMS environment, then the talk process may process the message. If, however, the method does not require a response, then the send process may process the message.

For example, if the method invoked by the CORBA process requires a response, the talk process may parse the message and create a second message for the IMS process based on the received message. The talk process may then send this second message to the IMS environment. The IMS environment may in turn start the IMS process to process the second message. Then, the talk process may receive a response from the IMS process, and send the response to the CORBA process that invoked the method. On the other hand, if the method invoked by the CORBA process does not require a response, the send process may parse the message and create a second message for the IMS process based on the received message. The send process may then send the message to the IMS environment, which may in turn start the IMS process to process the message. The send process may not receive or expect a response from the IMS process, and thus, the send process may not send a response to the CORBA process that invoked the method. Instead, the send process may send a message to the CORBA process indicating whether or not the IMS environment received the second message.

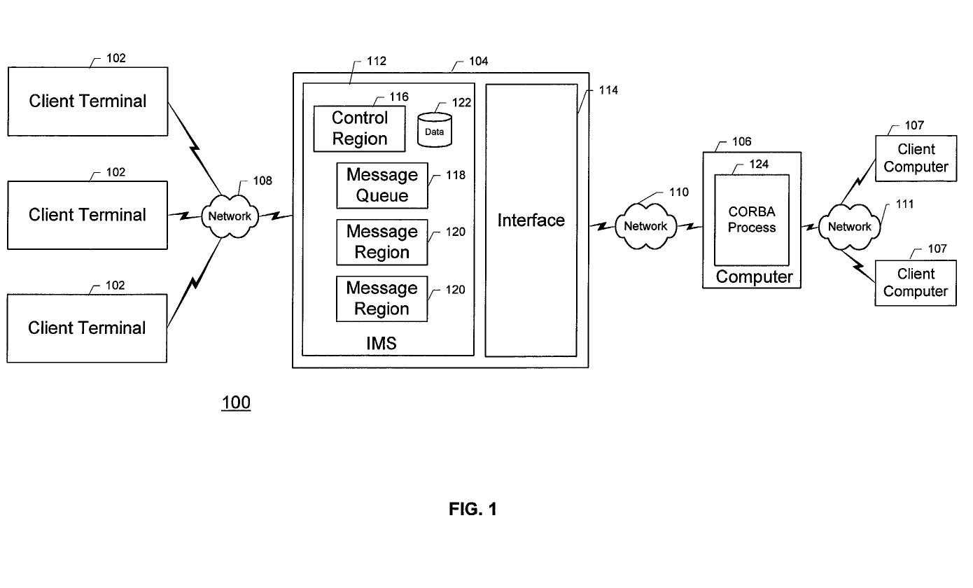

FIG. 1 is an exemplary block diagram of a system 100, in accordance with methods and systems consistent with the present invention. System 100 may include one or more client terminals 102, an IMS server 104, a computer 106, and one or more client computers 107. Client terminals 102 may be connected to IMS server 104 via a network 108, IMS server 104 may be connected to computer 106 via a network 110, and client computers 107 may be connected to computer 106 via a network 111.

Each client terminal 102 may include a computer or any other processor capable of communicating with IMS server 104 and displaying information. Client terminal 102 may include a terminal equipped with terminal emulation software for communicating with IMS server 104.

IMS server 104 may include a mainframe or a similar device capable of communicating with client terminals 102. For example, IMS server 104 may include an IBM 9672 Parallel Enterprise Server Generation 6, Model x.27 server manufactured by International Business Machines (IBM).

IMS server 104 may include an IMS environment 112 (e.g., IMS/ESA version 7.1) and an interface 114. Interface 114 may be coded to match a CORBA specification (e.g., CORBA Specification dated Feb. 25, 1997) defined by OMG. Interface 114 may run in its own separate address space outside of the IMS environment 112. Although not shown in FIG. 1, one skilled in the art will readily understand that IMS server 104 may also include other components, such as operating system software and one or more IMS processes that run in IMS environment 112. The operating system may include, for example, the OS/390 operating system, Release 2, Version 10, Put Level 0008.

IMS environment 112 may communicate with client terminals 102 and interface 114. IMS environment 112 may include a control region 116, a message queue 118, one or more message regions 120, and database 122.

The control region 116 may control the operations within IMS environment 112. For example, the control region 116 may receive a message from client terminal 102 and may send the received message to the message queue 118 for processing. The control region 116 may include an IMS scheduler that notifies message regions 120 of pending messages. The IMS scheduler may also start an IMS process to process a pending message.

The control region 116 may include the open transaction manager access (OTMA) interface for communicating with interface 114. The OTMA interface may use the storage defined by interface 114 (herein referred to as “OTMA pass area”) to store messages that need to be sent to interface 114.

The message queue 118 may queue the messages before they are processed by an IMS process, or are sent to client terminals 102 or interface 114. The messages may be sent to message queue 118 by control region 116.

IMS environment 112 also may include message region 120. An IMS process may run within message region 120 to process the messages in message queue 118.

Database 122 may store data (e.g., customer account information) and may be accessed by IMS processes to respond to a request from client terminal 102 (e.g., a request for the account balance of a customer).

IMS server 104 may also include interface 114 for facilitating communication between an IMS process running in IMS environment 112 and a CORBA process 124 running on computer 106. For example, interface 114 may communicate with the IMS process using the OTMA Callable Interface (OTMA C/I) and may communicate with CORBA process 124 using Object Request Broker (ORB) software (e.g., VisiBroker 3.2). The ORB software may manage the physical protocol interaction between interface 114 and CORBA process 124. In addition, interface 114 may include several methods that CORBA process 124 may invoke to communicate with the IMS process. These methods may be defined using OMG's IDL.

System 100 also may include computer 106 and one or more client computers 107. Computer 106 may include any computer or processor capable of running CORBA process 124, and client computer 107 may include any computer or processor capable of communicating with computer 106. It will be apparent to one skilled in the art that CORBA process 124 may include a CORBA server process that receives and processes messages (e.g., request for invocation of a certain method) from other processes or computers and/or may include a CORBA client process that sends messages to other processes or computers. For example, in one embodiment, CORBA process 124 may include a CORBA server process that receives messages from an IMS process via interface 114 and other computers (e.g., client computer 111) or processes. These other computers (e.g., client computer 111) may be connected to computer 106 via network 111. In this embodiment, interface 114 may act as a CORBA client. In another embodiment, CORBA process 124 may include a CORBA client process that sends messages to an IMS process via interface 114 and other computers or processes. In this embodiment, interface 114 may act as a CORBA server process. Additionally, in this embodiment, other computers (e.g., client computer 107) may send a message to other computers or processes (e.g., an IMS process) via the CORBA client process running on computer 106. In still another embodiment, CORBA process 124 may act both as a CORBA client process and a CORBA server process that sends and receives messages to other processes or computers.

As described above, client terminals 102 may be connected to IMS server 104 via a network 108, IMS server 106 may be connected to computer 106 via a network 110, client computers 107 may be connected to computer 106 via a network 111. Each of these networks may include, for example, a Local Area Network (LAN) or a Wide Area Network (WAN). In addition, the networks may also include a combination of public (e.g., Internet) and private networks.

Other system and network configurations will be apparent to those skilled in the art and are also within the scope of the present invention. For example, although only one IMS environment 112 and one CORBA process (i.e., CORBA process 124) are shown in FIG. 1, interface 114 may facilitate communication between IMS processes running in several IMS environments and several CORBA processes. Similarly, although only one IMS server 104 and one computer 106 are shown in FIG. 1, system 100 may include more than one IMS server 104 and one computer 106. System 100 also may include more than one instance of interface 114 and IMS environment 112 may communicate with all these instances. Moreover, although IMS environment 112 and interface 114 are shown as running on one server, server 104, in FIG. 1, they may run on different servers. Additionally, interface 114 may run on many operating systems (e.g., Windows NT and Unix).

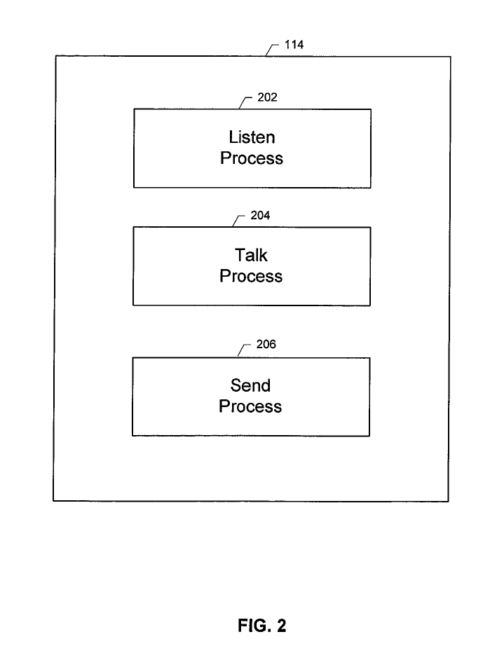

FIG. 2 is an exemplary block diagram of the several processes in interface 114, in accordance with methods and systems consistent with the present invention. Interface 114 may include a listen process 202, a talk process 204, and a send process 206, all of which may run on IMS server 104 in their own separate address spaces outside of the IMS environment. Listen process 202 may facilitate communications between an IMS process running in IMS environment 112 and CORBA process 124. On the other hand, talk process 204 and send process 206 may facilitate communications between CORBA process 124 and the IMS process.

Although only one instance of each of these processes is shown in FIG. 2, server 104 may include multiple instances of these three processes. Moreover, although only three processes are shown in FIG. 2, one skilled in the art will readily understand that interface 114 may have more than three processes, that these three processes may be combined into one process, or that each of these processes may be separated into various processes.

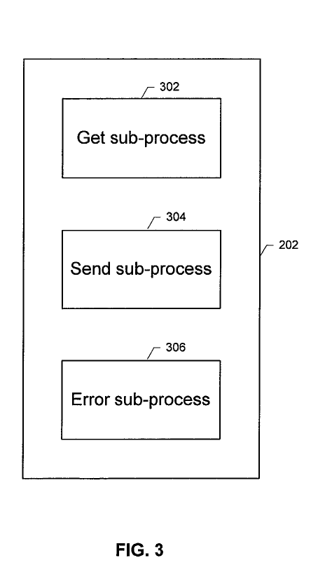

Listen process 202 will be described now with reference to FIGS. 3-6. FIG. 3 is an exemplary block diagram of the sub-processes in listen process 202, in accordance with methods and systems consistent with the present invention. Listen process 202 may include a get sub-process 302, a send sub-process 304, and an error sub-process 306. Get sub-process 302 may get a message from IMS environment 112; send sub-process may format and send the message to CORBA process 124; and error sub-process 306 may send an error message to IMS environment 112 if get sub-process 302 is not successful in getting the message from IMS environment 112 or if send sub-process 304 is not successful in sending the message to CORBA process 124.

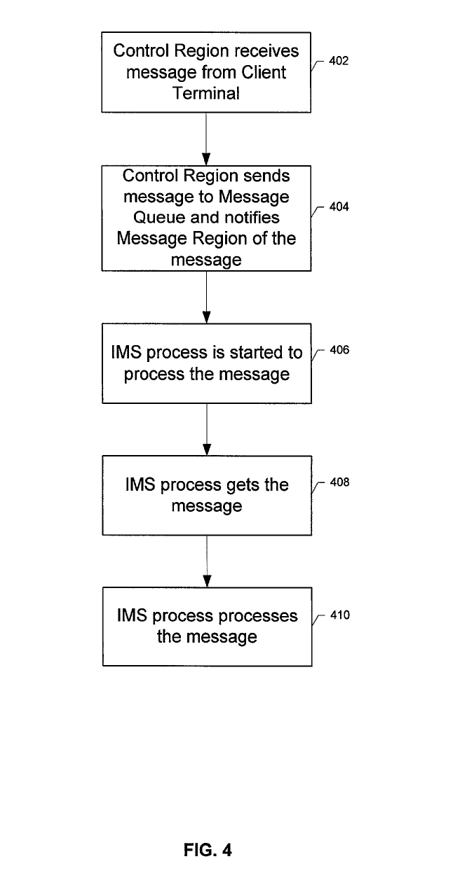

Although only one instance of each process is shown in FIG. 3, listen process 202 may include multiple instances of each of these three processes. For example, depending on the number of messages, another instance of each of these three processes may be started to process the messages. Each of these sub-processes will be explained in detail with reference to FIGS. 4-6.

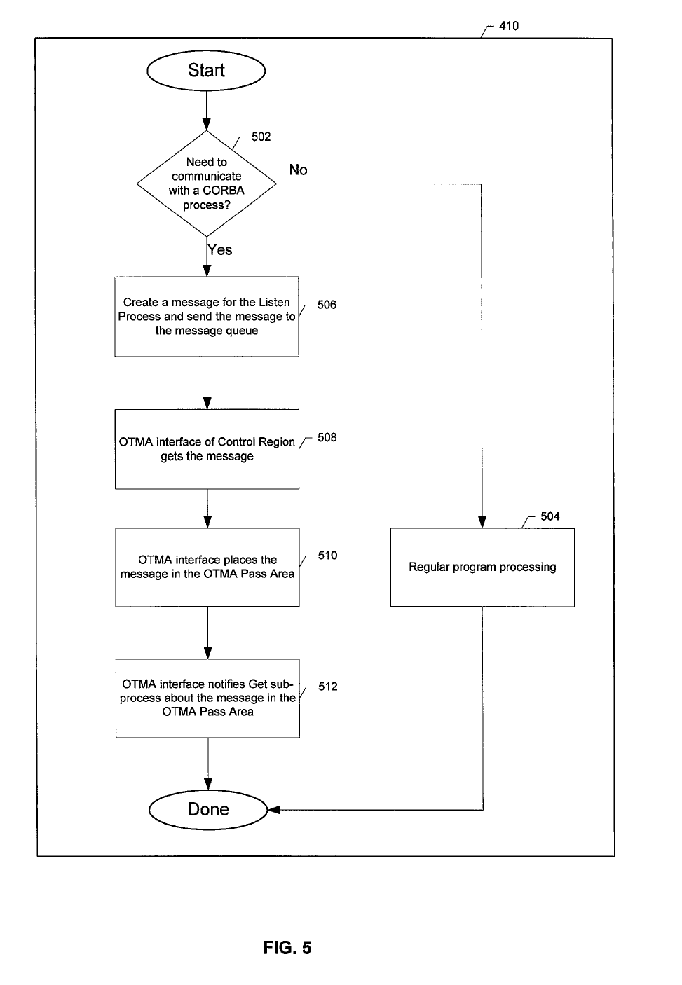

FIGS. 4 and 5 are exemplary flowcharts illustrating the steps performed by IMS environment 112 to process a message, in accordance with methods and systems consistent with the present invention. After a user uses client terminal 102 to logon to IMS server 104 and to send a message to IMS environment 112, control region 116 may receive the message from client terminal 102 (step 402). Control region 116 may then send this message to message queue 118. The IMS scheduler of control region 116 may in turn notify one of the message regions 120 of the message (step 404) and start an IMS process to process the message (step 406).

The IMS process may get this message from message queue 118 (step 408) and process this message (step 410). The processing of the message by the IMS process will be further explained with reference to FIG. 5.

As shown in FIG. 5, IMS process may determine if the message needs to be sent to CORBA process 124 (step 502). The message may need to be sent to CORBA process 124 if data (e.g., account balance) is needed from CORBA process 124 or if the IMS process needs CORBA process 124 to perform a certain function (e.g., transfer balances between two accounts, one existing in IMS environment 112 and the other in computer 106).

If the IMS process does not need to send a message to CORBA process 124, then the IMS process may process the message using normal methods (steps 502 and 504). For example, the IMS process may just update database 122 based on the message. Once the message has been processed, the IMS process may terminate.

If, however, the IMS process needs to send a message to CORBA process 124, the IMS process may create a message for listen process 202 (e.g., by designating the message with an alternate destination designation) and send the message to message queue 118. The message may include, for example, the operation that needs to be performed by CORBA process 124, any inputs needed to perform that operation, and identify the object on which the operation needs to be performed.

Next, the OTMA interface of control region 116 may get the message from message queue 118 (step 508) and place the message in the OTMA pass area (step 510). For example, the OTMA interface of control region 116 may get any messages that are designated with an alternate destination designation and send them to the OTMA pass area. Then, the OTMA interface may notify get process 302 about the message in the OTMA pass area (step 512) by, for example, posting its extended control block (ECB). Once the OTMA interface notifies get sub-process 302 about the message, the OTMA interface may wait for get sub-process 302 to get the message. After get sub-process 302 gets the message from the OTMA interface, OTMA interface may wait for another message or may continue processing by, for example, getting another message from message queue 118.

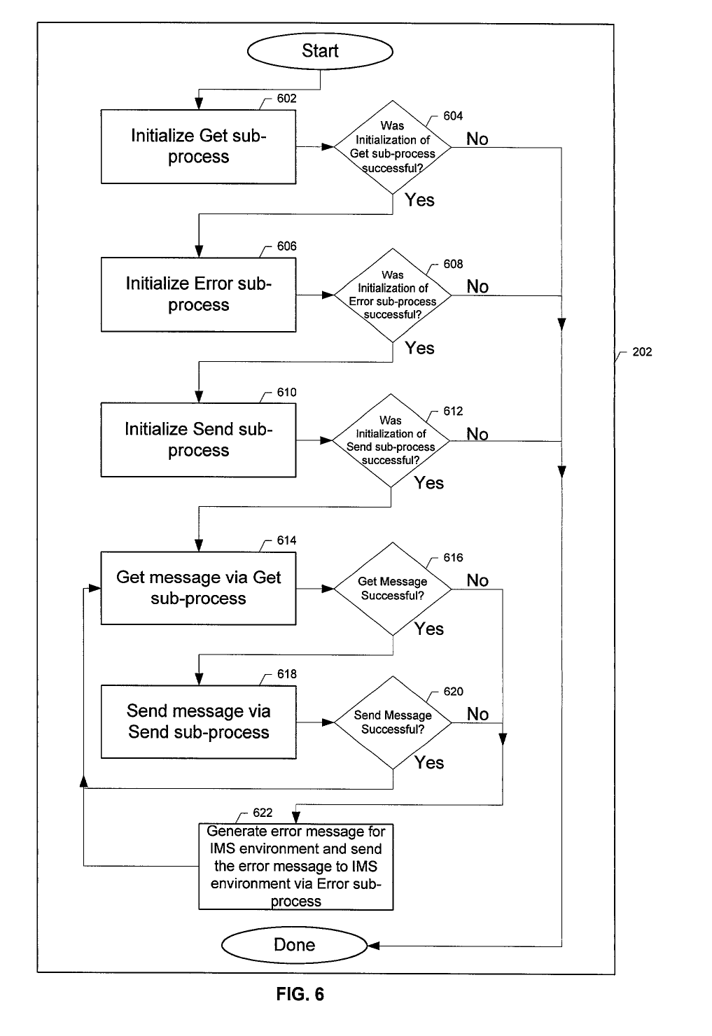

The process of initializing the get sub-process 302 along with a description of how listen process 202 sends a message to CORBA process 124 is explained now with reference to FIG. 6. As shown in FIG. 6, listen process 202 may initialize get sub-process 302 (step 602). During initialization, get sub-process 302 may allocate the OTMA pass area storage space and may provide the OTMA interface with the address of this OTMA pass area. It may also initialize communication with the OTMA interface, for example, by invoking several OTMA C/I methods.

Next, listen process 202 may determine if the initialization of get sub-process 302 is successful (step 604). If the initialization is not successful (e.g., get sub-process could not allocate the storage space or could not communicate with OTMA), then listen process 202 may terminate.

If the initialization of get sub-process 302 is successful, then listen process 202 may initialize error sub-process (step 606). During initialization, error sub-process 306 may allocate a storage space (herein referred to as “error storage space”) for local processing, and may also initialize communication with the OTMA interface.

Next, listen process 202 may determine if the initialization of error sub-process 306 is successful (step 608). If the initialization is not successful (e.g., error sub-process could not allocate a storage space or could not communicate with OTMA), then listen process 202 may terminate.

If the initialization of error sub-process 306 is successful, then listen process 202 may initialize send sub-process 304 (step 610). During initialization, send sub-process 304 may allocate a storage space (herein referred to as “send storage space”) for local processing, and the ORB software may attach to the ORB portion of CORBA process 125. The ORB software may facilitate send sub-process 304 in sending a message to CORBA process 124.

Next, listen process 202 may determine if the initialization of send sub-process 304 is successful (step 612). If the initialization is not successful (e.g., send sub-process could not allocate a storage space or the ORB software could not attach to the ORB portion of CORBA process 125), then listen process 202 may terminate.

If the initialization of send sub-process 304 is successful, then listen process 202 may tell get sub-process 302 to get a message from the IMS process through the OTMA interface (step 614). To get a message from the IMS environment, get sub-process 302 may wait until the OTMA interface notifies get sub-process that there is a message in the OTMA pass area. Then, when the OTMA interface notifies get sub-process 302 about the message in the OTMA pass area (step 512 of FIG. 5), get sub-process 302 may move the message from the OTMA pass area to a common processing area.

Next, listen process 202 may determine if get sub-process 302 successfully retrieved the message from the IMS process through the OTMA interface (step 616). For example, to determine if get sub-process 302 is successful, listen process 202 may check to see if get sub-process 302 generated an error message or if there is a message in the common processing area.

If listen process 202 determines that get sub-process 302 successfully retrieved the message from the IMS process through the OTMA interface, listen process 202 may tell send sub-process 304 to send the message to CORBA process 124 (step 618).

To send the message to CORBA process 124, send sub-process 304 may parse the message to determine, for example, the object, the operation that needs to be performed on the object, and the CORBA process to which the message should be sent. Send sub-process 304 may then reformat the message for the appropriate method call corresponding to the desired operation based on CORBA process's IDL. For example, send sub-process 304 may move data into one or more IDL structures recognizable by the CORBA process. The reformatting may be done in the send storage space. After formatting, send sub-process 304 may establish a connection with computer 106 and send the message to computer 106. Computer 106 may send the message to CORBA process 124, which may in turn invoke the requested method.

Next, listen process 202 determines if send sub-process 304 successfully sent the message successfully to computer 106 (step 620). For example, to determine if send sub-process 304 is successful, listen process 202 may check to see if CORBA process 124 generated an error, if send sub-process 304 generated an error, or if there is an error message in the send storage space.

If listen process 202 determines that send sub-process 304 is successful in sending the message, listen process 202 may get another message from the IMS process through the OTMA interface using get sub-process 302 (steps 620 and 614).

On the other hand, if listen process 202 determines that get sub-process 302 is not successful in retrieving the message from the IMS process (step 616) or if it determines that that send sub-process 304 is not successful in sending the message to computer 106 (step 620), then listen process 202 may generate an error message for IMS environment 112 and send it to IMS environment 112 using error sub-process 306 (step 622).

To process the error message, error sub-process 306 may parse the error message received from listen process 202 and create a message for IMS environment 112. The message may be formatted to a data structure recognizable by an IMS process. Once the message has been created, error sub-process 306 may send the message to IMS environment 112 via the OTMA interface.

Once an error message has been sent to IMS environment 112, listen process 202 may get another message from the IMS process through the OTMA interface using get sub-process 302 (steps 622 and 614).

As shown in FIG. 6, once listen process 202 initializes get sub-process 302, send sub-process 304, and error sub-process 306, these sub-processes continue to process messages in a loop. To exit this loop, a person (e.g., administrator) of IMS server 104 may need to terminate listen process 202. In an alternative embodiment, listen process 202 could be modified to include an exit from the loop. Other modifications to listen process 202 will be apparent to those skilled in the art and are also within the scope of the present invention. For example, the initialization steps (steps 602, 604, 606, 608, 610, and 612), and message processing steps (614, 616, 618, 620, and 622) could be separated into two separate processes.

In addition to facilitating communication from an IMS process running in IMS environment 112 to CORBA process 124, interface 124 also facilitates communication from CORBA process 124 to the IMS process. For example, CORBA process 124 may send a message to interface 114. The message may include a reference to a method that needs to be invoked by interface 114. Interface 114 may send the message to the IMS process using talk process 204 or send process 206 depending on the method that is being invoked. If the method that is being invoked by CORBA process 124 requires a response from an IMS process, then talk process 204 may process the message. If, however, the method that is being invoked by CORBA process 124 does not require a response, then the send process 206 may process the message.

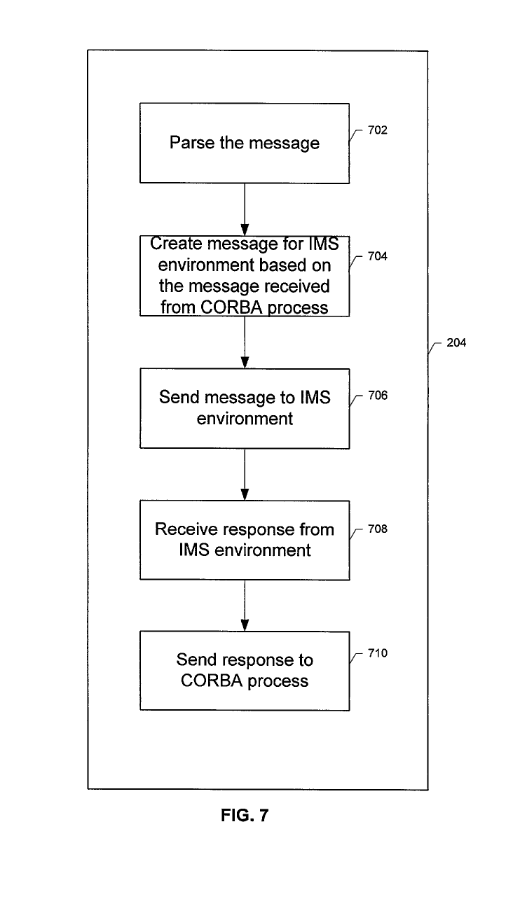

FIG. 7 is an exemplary flowchart illustrating the steps performed by talk process 204 to process a message, in accordance with methods and systems consistent with the present invention. When a message that requires a response is received from CORBA process 124, interface 114 may use talk process 204 to process and send the message to the IMS process. To process the message, talk process 204 may parse the message and create a message for IMS environment 112 based on the operation requested by CORBA process 124 (steps 702 and step 704). The message may be formatted to a data structure recognizable by IMS environment 112. For example, the data in the message may be moved into a structure recognizable by the IMS process. Once a message has been created, talk process 204 may send the message to the IMS environment 112 via the OTMA interface (step 706). IMS environment 112 may process the message, for example, by starting an IMS process corresponding to the operation requested by CORBA process 124, and may supply a response to talk process 204 (step not shown in figure). Talk process 204 may receive the response from IMS environment 112 and send the response to CORBA process (steps 708 and 710). The format of the response may be a simple data stream and talk process 204 may just forward this data stream to CORBA client process 124 without any modification. In another embodiment, talk process 204 may format the response to a certain format before sending it to CORBA client process 124.

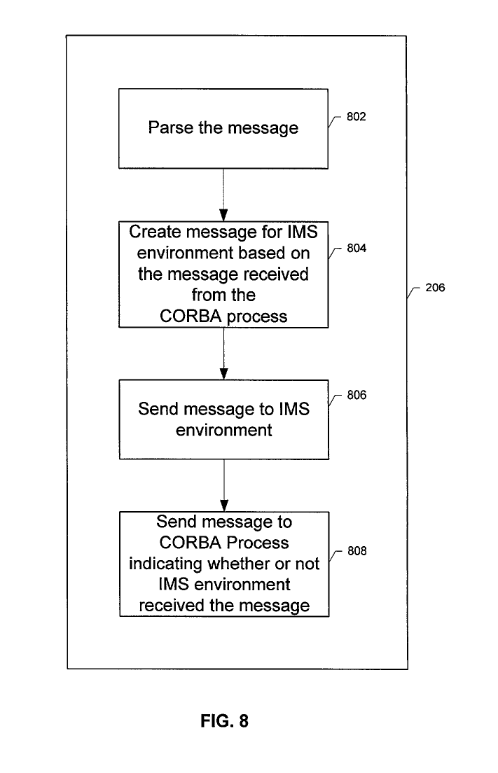

As described above, if CORBA process 124 does not require a response from IMS environment 112, interface 114 may process the message received from CORBA process 124 using send process 206. FIG. 8 is an exemplary flowchart illustrating the steps performed by a send process 206 to process such a message, in accordance with methods and systems consistent with the present invention. Send process 206 may parse the message and create a message for IMS environment 112 based on the operation requested by CORBA process 124 (steps 802 and 804). The message may be formatted to a data structure recognizable by IMS environment 112. For example, the data in the message may be moved into a structure recognizable by the IMS process. Once a message has been created, send process 206 may send the message to the IMS environment 112 (step 806). After sending the message to IMS environment 112, send process 206 may send a message to CORBA process 124 indicating whether or not the IMS environment received the second message (step 808). Upon receiving the message from send process 206, IMS environment 112 may process the message, for example, by starting an IMS process corresponding to the operation requested by CORBA process 124 (step not shown in figure).

The above-noted features, other aspects, and principles of the present invention may be implemented in various system or network configurations to provide automated and computational tools for facilitating communication between an IMS process and a CORBA process. Such configurations and applications may be specially constructed for performing the various processes and operations of the invention or they may include a general purpose computer or computing platform selectively activated or reconfigured by program code to provide the necessary functionality. The processes disclosed herein are not inherently related to any particular computer or other apparatus, and may be implemented by a suitable combination of hardware, software, and/or firmware. For example, various general purpose machines may be used with programs written in accordance with teachings of the invention, or it may be more convenient to construct a specialized apparatus or system to perform the required methods and techniques.

The present invention also relates to computer readable media that include program instruction or program code for performing various computer-implemented operations based on the methods and processes of the invention. The media and program instructions may be those specially designed and constructed for the purposes of the invention, or they may be of the kind well-known and available to those having skill in the computer software arts. The media may take many forms including, but not limited to, non-volatile media, volatile media, and transmission media. Non-volatile media includes, for example, optical or magnetic disks. Volatile media includes, for example, dynamic memory. Transmission media includes, for example, coaxial cables, copper wire, and fiber optics. Transmission media can also take the form of acoustic or light waves, such as those generated during radio-wave and infra-red data communications. Examples of program instructions include both machine code, such as produced by compiler, and files containing a high level code that can be executed by the computer using an interpreter.

Furthermore, it will be apparent to those skilled in the art that various modifications and variations can be made in the system and method of the present invention and in construction of this invention without departing from the scope or spirit of the invention.

Moreover, other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for facilitating communication between an Information Management System (IMS) process running in an IMS environment of a first computer and a Common Object Request Broker Architecture (CORBA) process running on a second computer, the method comprising:
receiving, from the IMS process, a message destined to the CORBA process;
converting, outside of the IMS environment but within the first computer, the message to a format recognizable by the CORBA process; and
sending the converted message to the CORBA process.

2. The method of claim 1, wherein the converting the message to a format recognizable by the CORBA process includes parsing the message received from the IMS process and inserting data from the parsed message into one or more interface definition language (IDL) structures recognizable by the CORBA process.

3. The method of claim 1, further comprising:
receiving, outside of the IMS environment but within the first computer, a first error message;
generating, outside of the IMS environment but within the first computer, a second error message based on the first error message; and
sending the second error message to the IMS environment.

4. The method of claim 3, wherein the generating a second error message based on the first error message includes formatting the second error message to a format recognizable by the IMS environment.

5. A method for facilitating communication between an Information Management System (IMS) process running in an IMS environment of a first computer and a Common Object Request Broker Architecture (CORBA) process running on a second computer, the method comprising:
receiving, from the CORBA process, at the first computer, a message destined to the IMS process;
converting, outside of the IMS environment but within the first computer, the message to a format recognizable by the IMS environment;
sending the converted message to the IMS environment.

6. The method of claim 5, further comprising:
receiving, outside of the IMS environment but within the first computer, a response to the converted message from the IMS environment; and
sending information in the response to the CORBA process.

7. The method of claim 5, wherein the converting the message to a format recognizable by the IMS environment includes parsing the message and inserting data from the parsed message into a structure recognizable by the IMS process.

8. The method of claim 5, further comprising sending a second message to the CORBA process indicating whether the IMS environment received the message.

9. A method for facilitating communication between an Information Management System (IMS) process running in an IMS environment and a Common Object Request Broker Architecture (CORBA) process, the method comprising:
receiving, from the IMS process, a message destined to the CORBA process;
converting, outside of the IMS environment, the message to a format recognizable by the CORBA process; and
sending the converted message to the CORBA process.

10. The method of claim 9, wherein the IMS process runs on a first computer and the CORBA process runs on a second computer.

11. The method of claim 10, wherein the converting, outside of the IMS environment, the message to a format recognizable by the CORBA process includes converting, outside of the IMS environment but within the first computer, the message to a format recognizable by the CORBA process.

12. A system for facilitating communication between an Information Management System (IMS) process running in an IMS environment of a first computer and a Common Object Request Broker Architecture (CORBA) process running on a second computer, the system comprising:
a memory including a program that
receives, from the IMS process, a message destined to the CORBA process,
converts, outside of the IMS environment but within the first computer, the message to a format recognizable by the CORBA process by inserting data from the message to one or more interface definition language (IDL) structures recognizable by the CORBA process, and
sends the converted message to the CORBA process; and
a processor that runs the program.

13. The system of claim 12, wherein the program further:
receives, outside of the IMS environment but within the first computer, a first error message;
generates, outside of the IMS environment but within the first computer, a second error message based on the first error message; and
sends the second error message to the IMS environment.

14. A system for facilitating communication between an Information Management System (IMS) process running in an IMS environment of a first computer and a Common Object Request Broker Architecture (CORBA) process running on a second computer, the system comprising:
a memory including a program that
receives, from the CORBA process, at the first computer, a message destined to the IMS process,
converts, outside of the IMS environment but within the first computer, the message to a format recognizable by the IMS environment by inserting data from the message to a structure recognizable by the IMS process, and
sends the converted message to the IMS environment,
a processor that runs the program.

15. The system of claim 14, wherein the program further:
receives, outside of the IMS environment but within the first computer, a response from the IMS environment, and
sends information in the response to the CORBA process.

16. The system of claim 14, wherein the program further sends a second message to the CORBA process indicating whether the IMS environment received the message.
